(19) United States
(12) Patent Application Publication
(10) Pub. No.: US 2012/0004341 A1
(43) Pub. Date: Jan. 5, 2012

(54) ALKALI SOLUBLE RESIN POLYMER AND NEGATIVE-TYPE PHOTOSENSITIVE RESIN COMPOSITION INCLUDING THE SAME

(75) Inventors: Han Soo KIM, Daejeon (KR); Hee Kwan PARK, Daejeon (KR); Ki Youl LEE, Daejeon (KR); Sang Kyu KWAK, Daejeon (KR); Yoon Hee HEO, Daejeon (KR); Chang Soon LEE, Daejeon (KR); Chang Ho CHO, Anseong-si (KR); Sun Hwa KIM, Daejeon (KR); Won Jin CHUNG, Daejeon (KR)

(73) Assignee: LG CHEM, LTD., Seoul (KR)

(21) Appl. No.: 13/176,209

(22) Filed: Jul. 5, 2011

(30) Foreign Application Priority Data
Jul. 5, 2010 (KR) 10-2010-0064298
Jun. 8, 2011 (KR) 10-2011-0055037

(51) Int. Cl. C08L 47/00; C08F 236/20

(52) U.S. Cl. 522/79; 526/318.44; 526/318.45

(57) ABSTRACT

Provided are an alkali soluble binder resin that includes a monomer including an unsaturated double bond, an unsaturated double bond character monomer including a carboxylic acid and an unsaturated double bond character monomer including an allyl group as a repeating unit, in which a molecular weight distribution (Mw/Mn) is in a range of about 2.0 to about 3.5, and a negative-type photosensitive resin composition including the alkali soluble binder resin. Re-solubility, fine-patterned substrate adhesion and dispersion stability may be improved by including the alkali soluble binder resin according to the present invention.

### CROSS-REFERENCE TO RELATED APPLICATIONS

This U.S. non-provisional patent application claims priority under 35 U.S.C. §119 to Korean Patent Applications Nos. 10-2010-0064298, filed on Jul. 5, 2010 and 10-2011-0055037, filed on Jun. 8, 2011, the entire contents of which are hereby incorporated by reference.

### BACKGROUND

The present invention disclosed herein relates to an alkali soluble resin polymer and a negative-type photosensitive resin composition including the same, and more particularly, to an alkali soluble binder resin having excellent re-solubility, dispersion stability, and substrate adhesion and a negative-type photosensitive resin composition including the same.

Recently, high reliability of materials is required for a process of manufacturing color filters in terms of cost reduction. When a material having low chemical resistance is used, limitations such as pigment leaching and pattern swelling may be generated due to an organic solvent used during rework processes of various layers formed on upper portions of color filters. Also, if a material having low sensitivity is used, a desired pattern may not be formed with a low amount of exposure. In order to resolve such limitations, an alkali soluble resin including a number of methacrylic or acrylic reactive groups is used because the resin can react with a polyfunctional monomer during exposure using. In this case, limitations such as pigment leaching or pattern swelling can be resolved by increasing cross linking density as well as making a composition highly sensitive.

However, since higher contrast and brightness than a typical liquid crystal display (LCD) TV are recently required in the LCD TV market, pigments having different types from a typical one are being introduced as well as increasing pigment concentrations and atomizing pigments. Under these circumstances, dispersion stability is deteriorated in a typical system including a number of methacrylic or acrylic reactive groups, and thus the viscosity or protrusions of a pigment dispersion increase. In addition, re-solubility is also deteriorated.

However, because the size of a substrate recently used in formation of color filters becomes larger, a method of coating a composition for a color filter is being replaced from a method of using a center dispensing-type spin coater to a method of using a slit nozzle having a smaller liquid outlet diameter.

Since a nozzle at the liquid outlet is small in the latter method of using a slit nozzle, there are many cases where a colored radiation-sensitive resin composition remains at the periphery of a nozzle tip after coating. When the remained resin composition is dried, the quality of a color filter is considerably deteriorated because the remained resin composition drops on a color filter as a dried foreign matter during next coating.

Therefore, to overcome such limitations, a resin composition having high cleanability with respect to a cleaning solvent, i.e., high solubility (hereinafter, referred to as the “re-solubility”) with respect to a cleaning solvent even after drying, is being required.

For example, in the case of a typical alkali soluble binder resin including a reactive group for improving re-solubility, an acrylic monomer including an unsaturated double bond and an unsaturated acrylic monomer including carboxylic acid are generally copolymerized, and then the alkali soluble binder resin is prepared by allowing an unsaturated double bond character acrylic monomer including an epoxy group to react with carboxylic acid.

Also, a copolymer of an acrylic monomer including an unsaturated double bond and an unsaturated acrylic monomer including an epoxy group is formed, and then a reactive group alcohol is formed thereto by allowing an unsaturated double bond character acrylic monomer including carboxylic acid to react with the epoxy group. Subsequently, an acid group is introduced by allowing the alcohol to react with acid anhydride.

According to the results of experiments carried out by the inventors, limitations in the deterioration of protruding property or re-solubility are observed when a resin including the foregoing reactive group is used, in comparison to when a resin having no reactive group is used. Among the reactive groups, an unfavorable result in re-solubility was obtained for an acrylic reactive group in comparison to a methacrylic reactive group. However, limitations were faced because desired levels of chemical resistance, sensitivity, or pattern characteristics may not be obtained in the case of a composition including the resin having no reactive group.

### SUMMARY

The present invention provides a negative-type photosensitive resin composition having improved dispersion stability, protrusion property, and re-solubility while maintaining chemical resistance, sensitivity, and pattern characteristics of a typical alkali soluble resin by introducing an allyl group to a resin as a reactive group having a structure different from a typical one.

In contrast, although a radiation-sensitive composition for forming a colored layer using allyl (meth)acrylate was disclosed in a publicized patent No. 2008-0084635, the composition of the patent has limitations in dispersion stability, protrusion property and re-solubility which are targeted in the present invention because its acid value is not clearly disclosed.

Also, as a new experimental result, the negative-type photosensitive resin composition has excellent fine-pattern generation capability. In general, since an aperture ratio of a mask is small in the case of a fine pattern, light-exposed portions will be less and many portions of the pattern are thus normally failed due to an erosion phenomenon of a developer during a development process. However, pattern fail may be prevented when the resin composition according to the present invention is introduced.

The present invention also provides an alkali soluble binder resin having excellent re-solubility.

The present invention also provides a negative-type photosensitive resin composition having excellent fine-pattern generation capability as well as maintaining chemical resistance and sensitivity by including the alkali soluble binder resin.

The present invention also provides an alkali soluble resin composition having excellent dispersion stability by including the alkali soluble binder resin.

The present invention also provides a photosensitive resin composition having excellent substrate adhesion by using the alkali soluble binder resin.

A copolymer of an acrylic monomer including an unsaturated double bond and an unsaturated acrylic monomer including carboxylic acid are generally formed, and then a resin polymer including a typical reactive group is prepared by allowing an unsaturated double bond character acrylic monomer including an epoxy group to react with carboxylic acid.

Also, a copolymer of an acrylic monomer including an unsaturated double bond and an unsaturated acrylic monomer including an epoxy group is formed, and then a reactive group alcohol is formed by allowing an unsaturated double bond character acrylic monomer including carboxylic acid to react with the epoxy group. Subsequently, an acid group is introduced by allowing the alcohol thus formed to react with acid anhydride. Such resin polymers have limitations in deteriorating the foregoing physical properties.

In contrast, because an alkali soluble binder resin according to the present invention is obtained by copolymerization of an acrylic monomer including an unsaturated double bond, an unsaturated double bond character acrylic monomer including carboxylic acid, and an unsaturated double bond character acrylic monomer including an allyl group, the foregoing limitations in the related art may be resolved.

### DETAILED DESCRIPTION OF THE EMBODIMENTS

Hereinafter, it will be described about an exemplary embodiment of the present invention in more detail.

An alkali soluble binder resin according to the present invention may be prepared by copolymerization of a monomer including an unsaturated double bond, an unsaturated double bond character monomer including carboxylic acid, and an unsaturated double bond character acrylic monomer including an allyl group, and a ratio (Mw/Mn) of Mw to Mn is in a range of 2.0 to 3.5.

The monomer including an unsaturated double bond is for improving physical properties such as compatibility, chemical resistance, and thermal resistance in an alkali soluble binder resin. Examples of the monomer including an unsaturated double bond may be one or more selected from the group consisting of aromatic vinyl compounds, N-substituted maleimide, unsaturated carboxylic acid ester, unsaturated carboxylic acid aminoalkyl ester, unsaturated carboxylic acid glycidyl ester, carboxylic acid vinyl ester, unsaturated ether, vinyl cyanide compounds, unsaturated amide, or aliphatic conjugated diene. However, the monomer including an unsaturated double bond is not limited thereto.

Examples of the aromatic vinyl compounds may be one or more selected from the group consisting of styrene, α-methylstyrene, p-styrenesulfonic acid, o-vinyltoluene, m-vinyltoluene, p-vinyltoluene, p-chlorostyrene, o-methoxystyrene, p-methoxystyrene, o-vinylbenzyl methyl ether, m-vinylbenzyl methyl ether, p-vinylbenzyl methyl ether, o-vinylbenzyl glycidyl ether, m-vinylbenzyl glycidyl ether, or p-vinylbenzyl glycidyl ether.

Examples of the N-substituted maleimide may be one or more selected from the group consisting of N-phenylmaleimide, N-o-hydroxyphenylmaleimide, N-m-hydroxyphenylmaleimide, N-p-hydroxyphenylmaleimide, N-o-methylphenylmaleimide, N-m-methylphenylmaleimide, N-p-methylphenylmaleimide, N-o-methoxyphenylmaleimide, N-m-methoxyphenylmaleimide, or N-p-methoxyphenylmaleimide.

Examples of the unsaturated carboxylic acid ester may be one or more selected from the group consisting of methyl (meth)acrylate, ethyl (meth)acrylate, n-propyl (meth)acrylate, i-propyl (meth)acrylate, n-butyl (meth)acrylate, i-butyl (meth)acrylate, sec-butyl (meth)acrylate, t-butyl (meth)acrylate, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, benzyl (meth)acrylate, cyclohexyl (meth)acrylate, phenyl (meth)acrylate, 2-methoxyethyl (meth)acrylate, 2-phenoxyethyl (meth)acrylate, diethylene glycol monomethyl ether (meth)acrylate, triethylene glycol monomethyl ether (meth)acrylate, propylene glycol monomethyl ether (meth)acrylate, dipropylene glycol monomethyl ether (meth)acrylate, isobornyl (meth)acrylate, tricyclo[5.2.1.02,6]decane-8-yl (meth)acrylate, 2-hydroxy-3 -phenoxypropyl (meth)acrylate, or glycerol (meth)acrylate.

Particular examples of the unsaturated carboxylic acid aminoalkyl ester may be one or more selected from the group consisting of 2-aminoethyl (meth)acrylate, 2-dimethylaminoethyl (meth)acrylate, 2-aminopropyl (meth)acrylate, 2-dimethylaminopropyl (meth)acrylate, 3-aminopropyl (meth)acrylate, or 3-dimethylaminopropyl (meth)acrylate.

An example of the unsaturated carboxylic acid glycidyl ester may be glycidyl (meth)acrylate.

Examples of the carboxylic acid vinyl ester may be vinyl acetate, vinyl propionate, vinyl butyrate, vinyl benzoate, etc.

Examples of the unsaturated ether may be vinyl methyl ether, vinyl ethyl ether, etc.

Examples of the vinyl cyanide compound may be (meth)acrylonitrile, α-chloroacrylonitrile, vinylidene cyanide, etc.

Examples of the unsaturated amide may be (meth)acrylamide, α-chloroacrylamide, N-(2-hydroxyethyl) (meth)acrylamide, etc.

Examples of the aliphatic conjugated diene may be 1,3-butadiene, isoprene, chloroprene, isoprene sulfonic acid, etc.

The monomer including an unsaturated double bond may be styrene, N-substitute maleimide, methyl (meth)acrylate, 2-hydroxyethyl (meth)acrylate, benzyl (meth)acrylate, phenyl (meth)acrylate, glycerolmono (meth)acrylate, etc., and may be used alone or by mixing two or more.

The monomer including an unsaturated double bond may be included in a range of 30 mol % to 89 mol % in a total alkali soluble binder resin in terms of developability, compatibility, thermal resistance, chemical resistance. For example, the monomer including an unsaturated double bond may be included in a range of 40 mol % to 60 mol % in the total alkali soluble binder resin.

Also, another component constituting an alkali soluble binder resin according to the present invention is an unsaturated double bond character monomer including carboxylic acid that gives developability with respect to an alkali developer in the alkali soluble binder resin. Particular examples of the unsaturated double bond character monomer including carboxylic acid may be one or more selected from the group consisting of (meth)acrylic acid, crotonic acid, itaconic acid, maleic acid, fumaric acid, monomethyl maleic acid, isoprene sulfonic acid, styrene sulfonic acid, 5-norbornene-2-carboxylic acid, mono[2-(meth)acryloyloxyethyl]phthalate, mono[2-(meth)acryloyloxyethyl]succinate, ω-carboxy polycaprolactone mono(meth)acrylate and combinations thereof. The (meth)acrylic acid may be used among the foregoing monomers.

The unsaturated double bond character monomer including carboxylic acid may be included in a range of 8 mol % to 67 mol % in the total alkali soluble binder resin in terms of having an appropriate solubility with respect to an alkali developer. For example, the unsaturated double bond character monomer including carboxylic acid may be included in a range of 13 mol % to 25 mol %.

Also, when an alkali soluble binder resin according to the present invention is included in a photosensitive resin composition having various applications, an unsaturated double bond character monomer including an allyl group represented as the following Chemical Formula 1 is included as a repeating unit for improvements of re-solubility, dispersion stability, and substrate adhesion.

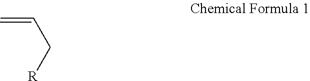

where R is (meth)acrylate, α-hydroxy methyl methacrylic acid, α-chloroacrylic acid, fumaric acid monoallyl, maleic acid monoallyl, benzoic acid monoallyl, or phthalic acid monoallyl.

Particular examples of the unsaturated double bond character monomer including an allyl group may be one or more selected from the group consisting of allyl (meth)acrylate, α-chloroacrylic acid allyl, α-hydroxy methyl methacrylic acid allyl, maleic acid diallyl, fumaric acid diallyl, phthalic acid diallyl, or benzoic acid diallyl. However, the unsaturated double bond character monomer including an allyl group is not limited thereto.

The unsaturated double bond character monomer including an allyl group may be included in a range of 3 mol % to 62 mol % in total alkali soluble binder resin in terms of effectiveness and stability. For example, the unsaturated double bond character monomer including an allyl group may be included in a range of 10 mol % to 40 mol %.

The alkali binder resin according to the present invention has a ratio (Mw/Mn) between Mw and Mn in a range of 2.0 to 3.5. The ratio may be in a range of 2.0 to 3.0. Since molecular weight is not sufficient when the ratio (molecular weight distribution, Mw/Mn) between Mw and Mn is less than 2.0, there is a limitation in reduction of reliability. When the ratio is more than 3.5, there are limitations in deterioration of reproducibility and substrate adhesion.

Since an allyl group, which is a reactive group having a structure different from a typical one, is introduced to an alkali soluble binder resin in the present invention, dispersion stability, protrusion property, and re-solubility may be improved as well as maintaining chemical resistance, sensitivity, and pattern characteristics included in a typical alkali soluble resin.

In comparison to decrease in dispersion stability due to reactivity and hydrophilicity of a methacrylic or acrylic reactive group in the case of typical alkali soluble resin in a mill base composition generally including pigment, dispersant, and binder resin, a binder resin according to the present invention includes an allyl group to have excellent dispersion stability during mixing of pigment and dispersant due to relatively lower reactivity and hydrophobicity than a methacrylic or acrylic reactive group.

Also, because an aperture ratio of a mask is generally small for a fine pattern, light-exposed portions will be less and many portions of a pattern are thus normally failed by an erosion phenomenon of a developer during a development process. However, pattern fail may be prevented when the resin according to the present invention is introduced. Therefore, the resin according to the present invention has excellent fine-pattern generation capability while maintaining chemical resistance and sensitivity.

Also, when the alkali soluble binder resin is applied to a transparent material such as a column spacer, the transparent material has an excellent substrate adhesion.

A method of preparing an alkali soluble binder resin according to the present invention is described below.

Each monomer constituting the alkali soluble binder resin according to the present invention, for example, a monomer including an unsaturated double bond, an unsaturated double bond character monomer including carboxylic acid, and an unsaturated double bond character monomer including an allyl group are copolymerized to prepared the alkali soluble binder resin.

Since the method of preparing the alkali soluble binder resin according to the present invention does not need to have a narrow molecular distribution as described above, the alkali soluble binder resin according to the present invention may be prepared by any one of general radical polymerization other than living radical polymerization, cation polymerization, anion polymerization, or condensation polymerization.

However, the radical polymerization may be used in consideration of ease or economy of preparation.

When the alkali soluble binder resin according to the present invention is prepared by a radical polymerization method, typical publicly known various initiators may be used and the initiator is not particularly limited. Also, polymerization time may be in a range of 1 hour to 48 hours and polymerization temperature may be in a range of 50° C. to 150° C.

The alkali soluble binder resin prepared according to the foregoing method may have an acid value range of 30 mg KOH/g to 150 mg KOH/g. When the acid value is less than 30 mg KOH/g, development is not facilitated. When the acid value is more than 150 mg KOH/g, there is a limitation in generation of excessive development. A weight-average molecular weight of the alkali soluble resin according to the present invention may be in a range of 3000 g/mol to 50000 g/mol. When the weight-average molecular weight of the alkali soluble resin according to the present invention is less than 3000 g/mol, there are many cases where patterns fail during a development process and chemical resistance is deteriorated. When the weight-average molecular weight of the alkali soluble resin according to the present invention is more than 50000 g/mol, there are many cases where development is not facilitated.

A photosensitive resin composition according to the present invention may include a polymerizable compound having an ethylenically unsaturated bond, a photoinitiator and a solvent to the alkali soluble binder resin.

Particular examples of the polymerizable compound having an ethylenically unsaturated bond may be one selected form the group consisting of pentaerythritol tri(metha)acrylate, pentaerythritol tetra(metha)acrylate, dipentaerythritol penta(metha)acrylate, dipentaerythritol, hexa(metha)acrylate, polyethylene glycol mono(metha)acrylate, or polypropylene glycol mono(metha)acrylate. However, the polymerizable compound having an ethylenically unsaturated bond is not limited thereto.

The photoinitiator may be one or more compounds selected from the group consisting of triazine compounds such as 2,4-trichloromethyl-(4′-methoxyphenyl)-6-triazine, 2,4-trichloromethyl-(4′-methoxystyryl)-6-triazine, and 2,4-trichloromethyl-(piperonyl)-6-triazine, acetophenone-based compounds such as 1-hydroxycyclohexyl phenyl ketone and 4-(2-hydroxyethoxy)-phenyl (2-hydroxy)propyl ketone, and benzophenone-based compounds such as benzophenone and 2,4,6-trimethylaminobenzophenone. However, the photoinitiator is not limited thereto.

Also, the solvent may be one or more selected from the group consisting of methyl ethyl ketone, propylene glycol diethyl ether, propylene glycol monomethyl ether acetate, cyclohexanone, 2-heptanone, isobutyl acetate, isopropyl butyrate, or 3-methoxybutyl acetate. However, the solvent is not limited thereto.

In the total photosensitive resin composition, the alkali soluble resin may be in a range of 1 wt % to 20 wt %, the polymerizable compound having an ethylenically unsaturated bond may be in a range of 1 wt % to 10 wt %, the photoinitiator may be in a range of 0.1 wt % to 5 wt %, and the solvent may be in a range of 10 wt % to 95 wt %. With respect to photoresists for a negative-type color filter and a black matrix, a colorant may be further included. At this time, the colorant may be one or more of a black pigment, a red pigment, a yellow pigment, a blue pigment, or a violet pigment. The black pigment may be carbon black, or titan black, and a color pigment may be phthalocyanine green, phthalocyanine blue, perylene blue, linol yellow, victoria pure blue, etc. Also, the colorant may be included in a range of 1 wt % to 20 wt % in the total resin composition.

The alkali soluble binder resin according to the present invention has fine-pattern generation capability as well as excellent re-solubility, chemical resistance and sensitivity when used in a color filter.

The alkali soluble binder resin according to the present invention may improve substrate adhesion when used in a transparent material such as a column spacer. However, uses of the alkali soluble binder resin and the photosensitive resin composition according to the present invention are not limited thereto.

Hereinafter, the present invention is described in more detail with reference to Examples of the present invention. The following Examples are only for describing the present invention and the present invention is not limited thereto.

### Synthesis Example 1

### Synthesis of Alkali Soluble Resin

10.31 g of methacrylic acid, 65.96 g of benzyl methacrylate, 15.74 g of allyl methacrylate, and 308 g of propylene glycol monomethyl ether acetate solvent are added to a 500 ml 3-neck flask, and then 2.76 g of 3-mercaptopropionic acid chain transfer agent is added while stirred under reflux and nitrogen atmosphere. A reaction was started by adding azobisisobutyronitrile (AIBN) as a reaction initiator. An alkali soluble resin according to the present invention was prepared by reacting at 70° C. for 9 hours.

A polystyrene equivalent weight-average molecular weight of the alkali soluble resin measure by gel permeation chromatography (GPC) was 11000 g/mol, an acid value was 81 mg KOH/g, and a molecular weight distribution (Mw/Mn) was 2.7.

### Synthesis Example 2

### Synthesis of Alkali Soluble Resin

10.31 g of methacrylic acid, 39.50 g of benzyl methacrylate, 23.34 g of styrene, 18.85 g of allyl methacrylate, and 308 g of propylene glycol monomethyl ether acetate solvent are added to a 500 ml 3-neck flask, and then 2.76 g of 3-mercaptopropionic acid chain transfer agent is added while stirred under reflux and nitrogen atmosphere. A reaction was started by adding AIBN as a reaction initiator. An alkali soluble resin according to the present invention was prepared by reacting at 70° C. for 9 hours.

A polystyrene equivalent weight-average molecular weight of the alkali soluble resin measure by GPC was 10500 g/mol, an acid value was 83 mg KOH/g, and a molecular weight distribution (Mw/Mn) was 2.6.

### Synthesis Example 3

### Synthesis of Alkali Soluble Resin

10.31 g of methacrylic acid, 32.11 g of methyl methacrylate, 33.40 g of styrene, 16.18 g of allyl methacrylate, and 308 g of propylene glycol monomethyl ether acetate solvent are added to a 500 ml 3-neck flask, and then 3.22 g of 3-mercaptopropionic acid chain transfer agent is added while stirred under reflux and nitrogen atmosphere. A reaction was started by adding AIBN as a reaction initiator. An alkali soluble resin according to the present invention was prepared by reacting at 70° C. for 9 hours.

A polystyrene equivalent weight-average molecular weight of the alkali soluble resin measure by GPC was 10000 g/mol, an acid value was 90 mg KOH/g, and a molecular weight distribution (Mw/Mn) was 2.6.

### Synthesis Example 4

### Synthesis of Alkali Soluble Resin

4.24 g of methacrylic acid, 25.08 g of styrene, 20.25 g of allyl methacrylate, and 308 g of propylene glycol monomethyl ether acetate solvent are added to a 500 ml 3-neck flask, and then 2.76 g of 3-mercaptopropionic acid chain transfer agent is added while stirring under reflux and nitrogen atmosphere. A reaction was started by adding AIBN as a reaction initiator. An alkali soluble resin according to the present invention was prepared by reacting at 70° C. for 9 hours.

A polystyrene equivalent weight-average molecular weight of the alkali soluble resin measure by GPC was 10000 g/mol, an acid value was 30 mg KOH/g, and a molecular weight distribution (Mw/Mn) was 2.6.

### Synthesis Example 5

### Synthesis of Alkali Soluble Resin

21.18 g of methacrylic acid, 27.84 g of methyl methacrylate, 28.96 g of styrene, 14.03 g of allyl methacrylate, and 308 g of propylene glycol monomethyl ether acetate solvent are added to a 500 ml 3-neck flask, and then 3.22 g of 3-mercaptopropionic acid chain transfer agent is added while stirred under reflux and nitrogen atmosphere. A reaction was started by adding AIBN as a reaction initiator. An alkali soluble resin according to the present invention was prepared by reacting at 70° C. for 9 hours.

A polystyrene equivalent weight-average molecular weight of the alkali soluble resin measure by GPC was 11500 g/mol, an acid value was 150 mg KOH/g, and a molecular weight distribution (Mw/Mn) was 3.1.

### Comparative Synthesis Example 1

### Synthesis of Alkali Soluble Resin

26.08 g of methacrylic acid, 41.43 g of benzyl methacrylate, 24.49 g of styrene, and 308 g of propylene glycol monomethyl ether acetate solvent are added, and then 2.76 g of 3-mercaptopropionic acid chain transfer agent is added while stirred under reflux and nitrogen atmosphere. A reaction was started by adding AIBN as a reaction initiator and the reaction was performed at 70° C. for 9 hours. Thereafter, 0.07 g of 4-methoxy hydroquinone (MEHQ) was added as a thermal polymerization inhibitor. 21.98 g of glycidyl methacrylate was added in the presence of a catalyst after heating at 110° C., and then an alkali soluble resin was prepared by reacting for 10 hours.

A polystyrene equivalent weight-average molecular weight of the alkali soluble resin measure by GPC was 10000 g/mol, an acid value was 80 mg KOH/g, and a molecular weight distribution (Mw/Mn) was 2.3.

### Comparative Synthesis Example 2

### Synthesis of Alkali Soluble Resin

10.31 g of methacrylic acid, 32.11 g of methyl methacrylate, 33.40 g of styrene, 16.18 g of allyl methacrylate, and 308 g of propylene glycol monomethyl ether acetate solvent are added to a 500 ml 3-neck flask, and then 5.52 g of 3-mercaptopropionic acid chain transfer agent is added while stirred under reflux and nitrogen atmosphere. A reaction was started by adding AIBN as a reaction initiator. An alkali soluble resin according to the present invention was prepared by reacting at 70° C. for 9 hours.

A polystyrene equivalent weight-average molecular weight of the alkali soluble resin measure by GPC was 6500 g/mol, an acid value was 100 mg KOH/g, and a molecular weight distribution (Mw/Mn) was 1.7.

### Comparative Synthesis Example 3

### Synthesis of Alkali Soluble Resin

25.41 g of methacrylic acid, 35.47 g of benzyl methacrylate, 20.96 g of styrene, 10.16 g of allyl methacrylate, and 308 g of propylene glycol monomethyl ether acetate solvent are added to a 500 ml 3-neck flask, and then 2.76 g of 3-mercaptopropionic acid chain transfer agent is added while stirred under reflux and nitrogen atmosphere. A reaction was started by adding AIBN as a reaction initiator. An alkali soluble resin according to the present invention was prepared by reacting at 70° C. for 9 hours.

A polystyrene equivalent weight-average molecular weight of the alkali soluble resin measure by GPC was 11200 g/mol, an acid value was 180 mg KOH/g, and a molecular weight distribution (Mw/Mn) was 2.8.

### Example 1

### Preparation of Pigment Dispersion

A mixture solution including 40 parts by weight of a Zn-based green pigment G 58 as a pigment, 12 parts by weight of a dispersant of DIC corporation as a dispersant, 40 parts by weight of the alkali soluble binder resin obtained in Synthesis Example 1 as a binder for dispersion, and 136 parts by weight of propylene glycol monomethyl ether acetate as a solvent was mixed and dispersed for 12 hours by means of a bead mill to prepare a pigment dispersion.

### Example 2

### Preparation of Pigment Dispersion

Except for using the resin obtained in the Synthesis Example 2, a pigment dispersion was prepared using the same method described in the Example 1.

### Example 3

### Preparation of Pigment Dispersion

Except for using the resin obtained in the Synthesis Example 3, a pigment dispersion was prepared using the same method described in the Example 1.

### Example 4

### Preparation of Pigment Dispersion

Except for using the resin obtained in the Synthesis Example 4, a pigment dispersion was prepared using the same method described in the Example 1.

### Example 5

### Preparation of Pigment Dispersion

Except for using the resin obtained in the Synthesis Example 5, a pigment dispersion was prepared using the same method described in the Example 1.

### Comparative Example 1

### Preparation of Pigment Dispersion

Except for using the resin obtained in the Comparative Synthesis Example 1, a pigment dispersion was prepared using the same method described in the Example 1.

### Comparative Example 2

### Preparation of Pigment Dispersion

Except for using the resin obtained in the Comparative Synthesis Example 2, a pigment dispersion was prepared using the same method described in the Example 1.

### Comparative Example 3

### Preparation of Pigment Dispersion

Except for using the resin obtained in the Comparative Synthesis Example 3, a pigment dispersion was prepared using the same method described in the Example 1.

### Example 6

### Preparation of Column Spacer Composition

The following photosensitive composition was used to form a column spacer. 8 parts by weight of the alkali soluble resin obtained in Synthesis Example 1 as an alkali soluble resin binder, 16 parts by weight of dipentaerythritol hexaacrylate as a polymerizable compound having an ethylenically unsaturated bond, 1 part by weight of 2-benzyl-2-dimethylamino-1-(4-molpolynophenyl)-butane-1-on (product name: Irgacure-369, Ciba-Geigy AG) as a photopolymerization initiator, and 79 parts by weight of propylene glycol monomethyl ether acetate (PGMEA) as an organic solvent were mixed by using a shaker for 3 hours.

### Example 7

### Preparation of Column Spacer Composition

Except for using 8 parts by weight of the alkali soluble resin obtained in Synthesis Example 2 as an alkali soluble resin binder, a composition was prepared using the method of Example 6.

### Example 8

### Preparation of Column Spacer Composition

Except for using 8 parts by weight of the alkali soluble resin obtained in Synthesis Example 3 as an alkali soluble resin binder, a composition was prepared using the method of Example 6.

### Example 9

### Preparation of Column Spacer Composition

Except for using 8 parts by weight of the alkali soluble resin obtained in Synthesis Example 4 as an alkali soluble resin binder, a composition was prepared using the method of Example 6.

### Example 10

### Preparation of Column Spacer Composition

Except for using 8 parts by weight of the alkali soluble resin obtained in Synthesis Example 5 as an alkali soluble resin binder, a composition was prepared using the method of Example 6.

### Comparative Example 3

### Preparation of Column Spacer Composition

Except for using 8 parts by weight of the alkali soluble resin obtained in Comparative Synthesis Example 1 as an alkali soluble resin binder, a composition was prepared using the method of Example 4.

### Comparative Example 4

### Preparation of Column Spacer Composition

Except for using 8 parts by weight of the alkali soluble resin obtained in Comparative Synthesis Example 2 as an alkali soluble resin binder, a composition was prepared using the method of Example 4.

### Comparative Example 5

### Preparation of Column Spacer Composition

Except for using 8 parts by weight of the alkali soluble resin obtained in Comparative Synthesis Example 3 as an alkali soluble resin binder, a composition was prepared using the method of Example 6.

### Experimental Example 1

### Re-solubility and Protrusion Property Evaluation of Pigment Dispersion

Pigment dispersions of the Examples and Comparative Examples were spin-coated on glass having a 5 cm×5 cm size, respectively, and then films were formed by prebaking at 100° C. for 2 minutes and 10 minutes. Each film formed was immersed in 20 ml of a propylene glycol monomethyl ether acetate solvent, and then re-solubility was evaluated according to the presence of dissolution of each film by the solvent. The results thereof are presented in Table 1 below.

Also, pigment dispersions of the Examples and Comparative Examples were spin-coated on glass having a 5 cm×5 cm size, respectively, and then films were formed by prebaking at 100° C. for 2 minutes. Each film formed was exposed to an energy of 40 mJ/cm² under a high-pressure mercury lamp using a photomask, and then postbake was performed for about 20 minutes. Glass surfaces and patterns were observed by an optical microscope, and the results thereof are presented in Table 1 below.

TABLE 1

Re-solubility

| | 110° C., | 110° C., | Presence of |
|---|---|---|---|
| | 2 minutes | 10 minutes | protrusions |
| Example 1 | ∘ | ∘ | no protrusions |
| Example 2 | ∘ | ∘ | no protrusions |
| Example 3 | ∘ | ∘ | no protrusions |
| Example 4 | ∘ | ∘ | no protrusions |
| Example 5 | ∘ | ∘ | no protrusions |
| Comparative | x | x | many protrusions |
| Example 1 | | | |
| Comparative | x | x | many protrusions |
| Example 2 | | | |
| Comparative | Δ | x | many protrusions |
| Example 3 | | | |

As shown in Table 1, both of re-solubility and dispersion stability (protrusion) of pigment dispersions (Examples 1 to 5) prepared by using an alkali soluble resin including an unsaturated double bond character monomer including an allyl group as a reactive group according to the present invention as an active group were excellent. However, with respect to a pigment dispersion (Comparative Example 1) prepared by using an alkali soluble resin not including an unsaturated double bond character monomer including an allyl group, a pigment dispersion (Comparative Example 2) having a molecular weight distribution value that does not pertain to the scope of the present invention even though an alkali soluble resin including an unsaturated double bond character monomer including an allyl group is used, or a pigment dispersion (Comparative Example 3) having an acid value that is out of the scope of the present invention even though a molecular weight distribution value pertains to the scope of the present invention while an unsaturated double bond character monomer including an allyl group is included, that pattern formation required is impossible due to a decrease in re-solubility and generation of many protrusions may be confirmed.

### Experimental Example 2

### Substrate Adhesion Evaluation of Column Spacer Pattern

Mixed photosensitive solutions obtained in Examples 6 to 10 and Comparative Examples 3 and 4 were filtered using a 5 μm size filter, respectively. Conformal films having a thickness of about 3.0 gm were formed by spin coating on glass and prebaking at about 100° C. for 2 minutes. The films were exposed to an energy of 40 mJ/cm² under a high-pressure mercury lamp by using a mask having a transmittance of 100% and various patterns in a linewidth range of 1 μm to 50 μm, and then patterns are developed with a KOH alkaline aqueous solution having a pH range of 11.3 to 11.7 and washed with deionized water. Column spacer patterns were formed by postbaking the washed patterns at 200° C. for about 50 minutes.

Minimum linewidths of the patterns thus formed were measured and qualities of substrate adhesion are presented in Table 2 below. It is considered that narrower the minimum linewidth, better the substrate adhesion.

TABLE 2

| | Minimum pattern linewidth (μm) |
|---|---|
| | remained after a development process |
| Example 6 | 11 |
| Example 7 | 10 |
| Example 8 | 12 |
| Example 9 | 12 |
| Example 10 | 12 |
| Comparative Example 3 | 20 |
| Comparative Example 4 | 23 |
| Comparative Example 5 | 25 |

From the results of Table 2, minimum pattern linewidths remained after a development process of the photosensitive resist compositions (Examples 6 to 10) prepared by using the alkali soluble resin including an allyl group as a reactive group according to the present invention are narrower than those of compositions of Comparative Examples 3 and 4. Accordingly, it may be understood that substrate adhesion is more improved in comparison to typical compositions (Comparative Examples 3 and 4) when the compositions according to the present invention is used. An alkali soluble binder resin according to the present invention has excellent re-solubility, dispersion stability, substrate adhesion, etc.

For example, when a photosensitive resin composition including the alkali soluble binder resin is used for a transparent color filter, re-solubility of the transparent color filter is excellent.

Also, the alkali soluble binder resin according to the present invention has excellent dispersion stability in a mill base of a photosensitive resin composition. The reason for this is that dispersion stability of a binder resin used in a typical photoresist (PR) composition is deteriorated due to reactivity and hydrophilicity of a methacrylic or acrylic reactive group, but on the other hand, the binder resin according to the present invention includes an allyl group to have excellent dispersion stability during mixing of pigment and dispersant due to relatively lower reactivity and hydrophobicity in comparison to the methacrylic or acrylic reactive group.

Also, the alkali soluble binder resin according to the present invention has excellent substrate adhesion when used in a transparent material such as a column spacer.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An alkali soluble binder resin comprising:
a monomer having an unsaturated double bond;
an unsaturated double bond character monomer having a carboxylic acid; and
an unsaturated double bond character monomer having an allyl group represented by Chemical Formula 1 below as a repeating unit,
wherein a molecular weight distribution (Mw/Mn) is in a range of about 2.0 to about 3.5. 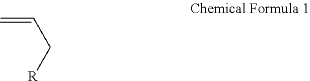
(where, R is any one selected from the group consisting of (meth)acrylate, α-hydroxy methyl methacrylic acid, α-chloroacrylic acid, fumaric acid monoallyl, maleic acid monoallyl, benzoic acid monoallyl, and phthalic acid monoallyl).

2. The alkali soluble binder resin of claim 1, wherein an acid value of the alkali soluble binder resin is in a range of about 30 mg KOH/g to about 150 mg KOH/g.

3. The alkali soluble binder resin of claim 1, wherein a weight-average molecular weight of the alkali soluble binder resin is in a range of about 3,000 to about 5,0000.

4. The alkali soluble binder resin of claim 1, wherein the monomer having an unsaturated double bond is one or more selected from the group consisting of aromatic vinyl compounds, N-substituted maleimide, unsaturated carboxylic acid ester, unsaturated carboxylic acid aminoalkyl ester, unsaturated carboxylic acid glycidyl ester, carboxylic acid vinyl ester, unsaturated ether, unsaturated amide, vinyl cyanide compounds, and aliphatic conjugated diene.

5. The alkali soluble binder resin of claim 4, wherein the aromatic vinyl compound is one or more selected from the group consisting of styrene, α-methylstyrene, p-styrenesulfonic acid, o-vinyltoluene, m-vinyltoluene, p-vinyltoluene, p-chlorostyrene, o-methoxystyrene, m-methoxystyrene, p-methoxystyrene, o-vinylbenzyl methyl ether, m-vinylbenzyl methyl ether, p-vinylbenzyl methyl ether, o-vinylbenzyl glycidyl ether, m-vinylbenzyl glycidyl ether, and p-vinylbenzyl glycidyl ether.

6. The alkali soluble binder resin of claim 4, wherein the N-substituted maleimide is one or more selected from the group consisting of N-phenylmaleimide, N-o-hydroxyphenylmaleimide, N-m-hydroxyphenylmaleimide, N-p-hydroxyphenylmaleimide, N-o-methylphenylmaleimide, N-m-methylphenylmaleimide, N-p-methylphenylmaleimide, N-o-methoxyphenylmaleimide, N-m-methoxyphenylmaleimide, and N-p-methoxyphenylmaleimide.

7. The alkali soluble binder resin of claim 4, wherein the unsaturated carboxylic acid ester is one or more selected from the group consisting of methyl (meth)acrylate, ethyl (meth)acrylate, n-propyl (meth)acrylate, i-propyl (meth)acrylate, n-butyl (meth)acrylate, i-butyl (meth)acrylate, sec-butyl (meth)acrylate, t-butyl (meth)acrylate, 2-hydroxyethyl (meth)acrylate, 2-hydroxypropyl (meth)acrylate, 3-hydroxypropyl (meth)acrylate, 2-hydroxybutyl (meth)acrylate, 3-hydroxybutyl (meth)acrylate, 4-hydroxybutyl (meth)acrylate, benzyl (meth)acrylate, cyclohexyl (meth)acrylate, phenyl (meth)acrylate, 2-methoxyethyl (meth)acrylate, 2-phenoxyethyl (meth)acrylate, diethylene glycol monomethyl ether (meth)acrylate, triethylene glycol monomethyl ether (meth)acrylate, propylene glycol monomethyl ether (meth)acrylate, dipropylene glycol monomethyl ether (meth)acrylate, isobornyl (meth)acrylate, tricyclo[5.2.1.02,6]decane-8-yl (meth)acrylate, 2-hydroxy-3-phenoxypropyl (meth)acrylate, and glycerol (meth)acrylate.

8. The alkali soluble binder resin of claim 4, wherein the unsaturated carboxylic acid aminoalkyl ester is one or more selected from the group consisting of 2-aminoethyl (meth)acrylate, 2-dimethylaminoethyl (meth)acrylate, 2-aminopropyl (meth)acrylate, 2-dimethylaminopropyl (meth)acrylate, 3-aminopropyl (meth)acrylate, and 3-dimethylaminopropyl (meth)acrylate.

9. The alkali soluble binder resin of claim 4, wherein the unsaturated carboxylic acid glycidyl ester is glycidyl (meth)acrylate.

10. The alkali soluble binder resin of claim 4, wherein the carboxylic acid vinyl ester is one or more selected from the group consisting of vinyl acetate, vinyl propionate, vinyl butyrate, and vinyl benzoate.

11. The alkali soluble binder resin of claim 4, wherein the unsaturated ether is any one of vinyl methyl ether or vinyl ethyl ether.

12. The alkali soluble binder resin of claim 4, wherein the vinyl cyanide compound is one or more selected from the group consisting of (meth)acrylonitrile, α-chloroacrylonitrile, and vinylidene cyanide.

13. The alkali soluble binder resin of claim 4, wherein the unsaturated amide is one or more selected from the group consisting of (meth)acrylamide, α-chloroacrylamide, and N-(2-hydroxyethyl) (meth)acrylamide.

14. The alkali soluble binder resin of claim 4, wherein the aliphatic conjugated diene is one or more selected from the group consisting of 1,3-butadiene, isoprene, chloroprene, and isoprene sulfonic acid.

15. The alkali soluble binder resin of claim 1, wherein the unsaturated double bond character monomer having carboxylic acid is one or more selected from the group consisting of (meth)acrylic acid, crotonic acid, itaconic acid, maleic acid, fumaric acid, monomethyl maleic acid, isoprene sulfonic acid, styrene sulfonic acid, 5-norbornene-2-carboxylic acid, mono[2-(meth)acryloyloxyethyl]phthalate, mono[2-(meth)acryloyloxyethyl]succinate, ω-carboxy polycaprolactone mono(meth)acrylate and a combination thereof.

16. The alkali soluble binder resin of claim 1, wherein the unsaturated double bond character monomer having an allyl group is one or more selected from the group consisting of allyl (meth)acrylate, α-chloroacrylic acid allyl, α-hydroxymethyl methacrylic acid allyl, maleic acid diallyl, fumaric acid diallyl, phthalic acid diallyl, and benzoic acid diallyl.

17. The alkali soluble binder resin of claim 1, wherein the alkali soluble binder resin comprises about 30 mol % to about 89 mol % of the monomer having an unsaturated double bond, about 8 mol % to about 67 mol % of the unsaturated double bond character monomer including carboxylic acid, and about 3 mol % to about 62 mol % of the unsaturated double bond character monomer including an allyl group.

18. The alkali soluble binder resin of claim 1, wherein the alkali soluble binder resin is prepared by radical polymerization of the monomer including an unsaturated double bond, the unsaturated double bond character monomer including carboxylic acid, and the unsaturated double bond character monomer including an allyl group.

19. A photosensitive resin composition comprising the alkali soluble binder resin of claim 1.

20. The photosensitive resin composition of claim 19, wherein the photosensitive resin composition further comprises a polymerizable compound having an ethylenically unsaturated bond, a photoinitiator, and a solvent.

21. The photosensitive resin composition of claim 20, wherein the photosensitive resin composition comprises about 1 wt % to about 20 wt % of the alkali soluble resin, about 1 wt % to about 10 wt % of the polymerizable compound having an ethylenically unsaturated bond, about 0.1 wt % to about 5 wt % of the photoinitiator, and the residual solvent.

22. The alkali soluble binder resin of claim 20, wherein the polymerizable compound having an ethylenically unsaturated bond is one or more selected form the group consisting of pentaerythritol tri(metha)acrylate, pentaerythritol tetra(metha)acrylate, dipentaerythritol penta(metha)acrylate, dipentaerythritol, hexa(metha)acrylate, polyethylene glycol mono(metha)acrylate, and polypropylene glycol mono(metha)acrylate.

23. An organic light-emitting diode (OLED), a liquid crystal display (LCD), or a semiconductor insulation layer is prepared by including the photosensitive resin composition of claim 19.
